(19) United States
(12) Patent Application Publication
(10) Pub. No.: US 2018/0191859 A1
(43) Pub. Date: Jul. 5, 2018

(54) NETWORK RESOURCE SCHEDULERS AND SCHEDULING METHODS FOR CLOUD DEPLOYMENT

(71) Applicants: Ranjan SHARMA, New Albany, OH (US); Helmut RAETHER, Shorewood, IL (US)

(72) Inventors: Ranjan SHARMA, New Albany, OH (US); Helmut RAETHER, Shorewood, IL (US)

(21) Appl. No.: 15/393,757

(22) Filed: Dec. 29, 2016

(51) Int. Cl. H04L 29/08

(52) U.S. Cl. CPC H04L 67/32; H04L 67/10

(57) ABSTRACT

In scheduling network resource for cloud network environment including a plurality of hosts, a scheduler determines whether one or more hosts from among the plurality of hosts are available to host a first virtual machine by filtering the plurality of hosts based on (i) first virtual machine type indicator information associated with a request to schedule the first virtual machine and (ii) second virtual machine type indicator information associated with the plurality of hosts. If one or more hosts are available to host the first virtual machine, the scheduler selects a host based on selection criteria associated with the filtered plurality of hosts, and schedules the first virtual machine to run on the selected host. The scheduler updates the second virtual machine type indicator information for the selected host to indicate that the first virtual machine is scheduled to run on the selected host.

### BACKGROUND

### Field

One or more example embodiments provide network resource schedulers and/or methods for scheduling resources for cloud deployments.

### Discussion of Related Art

As cloud deployments become the industry norm, service providers and network function virtualization (NFV) vendors have been actively aligning with a common denominator for interoperability and “playing by the rules.” OpenStack is an open source software used in private and public cloud deployments. OpenStack allows control of a “resource pool” that includes resources for computation, networking and storage. This control is provided via a dashboard (e.g., OpenStack Horizon) or through the OpenStack application programming interface (API), which works with heterogeneous resources that may be from multiple vendors.

OpenStack provides a framework for applications to work with a virtualized environment, where the applications may be executed on one or more virtual machines (VMs), which communicate with each other as necessary, and exhibit elasticity that allows the applications to work with an orchestration layer to reserve or release resources as necessary.

### SUMMARY

One or more example embodiments enable association of virtual machine type indicator information (sometimes referred as a “color,” “color value,” or “color attribute”) with a host according to the type or types of high availability (HA) virtual machine(s) scheduled to run on the host. The virtual machine type indicator information may be indicative of one or more types of virtual machines at any time, and the virtual machine types for modules within an application may advertise their own virtual machine type indicator information in addition to affinity and anti-affinity virtual machine type indicator information, as appropriate.

At least some example embodiments enable virtual machines identified by a virtual network function (VNF) provider to be declared as high availability (HA) components by their color attribute in the virtual hardware (e.g., Heat) template files for orchestration. A scheduler (e.g., a Nova Scheduler) may utilize the color attributes of the virtual machines as a filter to match potential hosts, which are capable of hosting the requested virtual machine, based on the hosts' current color values. A host's current color value may be dynamically altered as virtual machines are scheduled and de-scheduled for allocation from the host.

In one example, a color value for a host may be used to determine a list of hosts available to host virtual machines of the same type (e.g., same color value) across different stacks. When a virtual machine is allocated/scheduled to run on a host, a database entry for the host (e.g., a compute_nodes database (DB) entry for the host) is updated so that the new color value of the host becomes, for example, (compute_node==uuid.color XOR VM.color), which flips a bit in the color value of the host. When a virtual machine is de-allocated/de-scheduled from the host, the database entry for the host (e.g., a compute_nodes database (DB) entry for the host) is again updated so that the new color value of the host becomes, for example, (compute_node==uuid.color XOR VM.color), which again flips the bit in the color value of the host. According to at least some example embodiments, since the color value is part of the compute node infrastructure, the color value is visible to the stack that is being created, and by all other subsequent stacks.

At least one example embodiment provides a method for network resource scheduling in a cloud network environment including a plurality of hosts, the method comprising: determining whether one or more hosts from among the plurality of hosts are available to host a first virtual machine by filtering the plurality of hosts based on (i) first virtual machine type indicator information associated with a request to schedule the first virtual machine and (ii) second virtual machine type indicator information associated with the plurality of hosts; selecting a host from among the one or more hosts based on selection criteria associated with the filtered plurality of hosts, if the determining determines that one or more hosts are available to host the first virtual machine; scheduling the first virtual machine to run on the selected host; and updating the second virtual machine type indicator information for the selected host to indicate that the first virtual machine is scheduled to run on the selected host.

At least one other example embodiment provides a server to schedule network resources in a cloud network environment including a plurality of nodes. According to at least this example embodiment, the server comprises: a memory storing computer readable instructions; and one or more processors connected to the memory. The one or more processors are configured to execute the computer readable instructions to: determine whether one or more hosts from among the plurality of hosts are available to host a first virtual machine by filtering the plurality of hosts based on (i) first virtual machine type indicator information associated with a request to schedule the first virtual machine and (ii) second virtual machine type indicator information associated with the plurality of hosts; select a host from among the one or more hosts based on selection criteria associated with the filtered plurality of hosts, if one or more hosts are available to host the first virtual machine; schedule the first virtual machine to run on the selected host; and update the second virtual machine type indicator information for the selected host to indicate that the first virtual machine is scheduled to run on the selected host.

At least one other example embodiment provides a non-transitory computer-readable storage medium storing computer readable instructions that, when executed by one or more processors, cause the one or more processors to perform a method for network resource scheduling in a cloud network environment including a plurality of hosts, the method comprising: determining whether one or more hosts from among the plurality of hosts are available to host a first virtual machine by filtering the plurality of hosts based on (i) first virtual machine type indicator information associated with a request to schedule the first virtual machine and (ii) second virtual machine type indicator information associated with the plurality of hosts; selecting a host from among the one or more hosts based on selection criteria associated with the filtered plurality of hosts, if the determining determines that one or more hosts are available to host the first virtual machine; scheduling the first virtual machine to run on the selected host; and updating the second virtual machine type indicator information for the selected host to indicate that the first virtual machine is scheduled to run on the selected host.

According to one or more example embodiments, the first virtual machine type indicator information may include at least one first bit; the second virtual machine type indicator information may include a plurality of second bits; and a value of at least one second bit among the plurality of second bits may be changed based on the first virtual machine type indicator information.

The plurality of second bits may be a sequence of bits in the form of a binary value; and the at least one second bit among the plurality of second bits may be a second bit at a position in the sequence of bits corresponding to the type of virtual machine indicated by the first virtual machine type indicator information.

The scheduler may filter out hosts currently hosting a same type of virtual machine as the first virtual machine, from among the plurality of hosts, to identify a subset of the plurality of hosts. The scheduler may select the host from among the subset of the plurality of hosts.

The selection criteria for a host among the filtered plurality of hosts may include at least one of: available CPU resources at the host; available random access memory resources at the host; available memory storage at the host; information associated with device pools at the host; topology information associated with the host; or hosted virtual machine indicator information regarding virtual machine instances hosted by the host.

According to at least some example embodiments, the scheduler may de-schedule the first virtual machine from the selected host; and update the second virtual machine type indicator information for the selected host to indicate that the first type of virtual machine has been de-scheduled from the selected host.

The first virtual machine may be a high availability virtual machine; the scheduler may determine that two or more hosts are available to host the first virtual machine; and the scheduler may select a host from among the two or more hosts based on a number of high availability virtual machines currently hosted on each of the two or more hosts. The selected host may be the host currently hosting a least number of high availability virtual machines.

The first virtual machine may be a virtual network function including a plurality of virtual machine instances.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention.

FIG. 1 is a diagram illustrating an example cloud deployment architecture.

FIG. 2 is a flow chart illustrating an example embodiment of a method for network resource scheduling for cloud deployment.

FIG. 3 is a flow chart illustrating an example embodiment of a method for network resource de-scheduling for cloud deployment.

FIG. 4 provides a general architecture and functionality suitable for implementing functional elements described herein or portions of functional elements described herein.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing hosts, computers, cloud based servers, web servers, etc. Such existing hardware may include one or more Central Processing Units (CPUs), system-on-chip (SOC) devices, digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

The terms “including” and/or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

As discussed herein, hosts, web servers, cloud servers, etc., which are sometimes referred to collectively as “hosts,” may be commercial off-the-shelf (COTS) computer hardware that can be used to run multiple applications concurrently and/or simultaneously and often on the same host.

According to example embodiments, schedulers, hosts, servers, etc., may be (or include) hardware, firmware, hardware executing software or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs) computers or the like configured as special purpose machines to perform the functions described herein as well as any other well-known functions of these elements. In at least some cases, CPUs, SOCs, DSPs, ASICs and FPGAs may generally be referred to as processing circuits, processors and/or microprocessors.

The schedulers, hosts, servers, etc., may also include various interfaces including one or more transmitters/receivers connected to one or more antennas, a computer readable medium, and (optionally) a display device. The one or more interfaces may be configured to transmit/receive (wireline and/or wirelessly) data or control signals via respective data and control planes or interfaces to/from one or more switches, gateways, MMEs, controllers, other eNBs, client devices, etc.

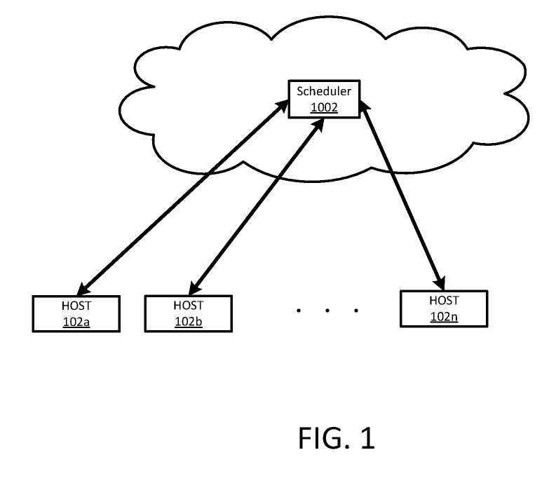

FIG. 1 is a diagram illustrating a simplified example of the OpenStack Nova system architecture. The Nova system architecture is a virtualized environment comprised of multiple server processes, each performing different functions.

Referring to FIG. 1, the simplified Nova system architecture includes a Nova scheduler 1002 in two-way communication with a plurality of hosts 102a, 102b, . . . , 102n. The Nova scheduler 1002 and the plurality of hosts 102a, 102b, . . . , 102n may be in two-way communication via one or more networks (e.g., wired or wireless) such as the Internet, one or more wireless local area networks (WLANs), LANs wide-area networks (WANs), 3^{rd}, 4^{th} and/or 5^{th} Generation wireless networks, etc. The Nova scheduler 1002 may sometimes be referred to as a scheduler.

Unlike a bare metal deployment that is right-sized from the beginning and runs specific applications on dedicated hardware, which is often purpose-built, a virtualized environment such as that shown in FIG. 1 brings COTS hardware that can be used to run multiple applications concurrently and/or simultaneously and often on the same host. There is no fixed assignment of scheduling an application to run on a specific host, but rather the scheduling is done via a scheduler, such as the Nova scheduler 1002.

Although not shown for the sake of clarity, a Nova system architecture, such as that shown in FIG. 1, may have availability zones, host aggregates, networks, storage, and other components as is well-known in the art. In this regard, a Nova scheduler works with a pool of compute resources, which includes hosts, networks, storage and other components. A compute resource may be characterized by the number of virtual CPUs (vCPUs), memory and storage and uses networking ports for communications. A compute resource may also characterized by other properties like availability zone, aggregate, etc. In some examples discussed herein, a host may also be referred to as a compute node.

A Nova scheduler, such as the Nova scheduler 1002, includes various modules or elements, such as an application programming interface (API), scheduler, conductor, and compute. Because these modules, and functionality thereof, are generally known, a detailed discussion is omitted.

A Nova scheduler also includes a Nova database (DB). The Nova database stores configuration, assignments and run-time state of the cloud deployment infrastructure, including any instance type available for use, instances already in use, networks, IP addresses, etc. The Nova database of interest with regard to example embodiments discussed herein is referred to as the “compute_nodes” database, which captures the capabilities (e.g., vCPUs, memory, networking, etc.) and state (e.g., how much of each type of resources is used, how much is available) for each host. The compute_nodes database exhibits Atomicity, Consistency, Isolation, Durability (ACID) constraints, so that resource reservation and allocation work with concurrent database transactions. Atomicity ensures the “all or nothing” part of resource allocation.

OpenStack provides a framework for applications to work with a virtualized environment, where the applications may be executed in one or more “virtual machines,” which communicate with each other as necessary, and exhibit elasticity that allows the applications to work with an orchestration layer to reserve or release resources as necessary.

Within the OpenStack platform, a stack, such as a virtual network function (VNF), includes one or more virtual machines running different software and processes, on top of standard servers, switches and storage devices, or even cloud computing infrastructure, instead of having custom hardware appliances for each network function.

The placement of the virtual machines on the hosts is controlled by policies that apply to a particular application. For example, in a high availability (HA) configuration, if an application has an active/standby module pair, then the orchestration policy for placing these virtual machines (sometimes referred to herein as HA virtual machines or HA virtual machine instances) may choose different hosts, different racks, different host aggregates or different availability zones as defined in the OpenStack Nova module. For module instances that constitute a pair from an availability perspective within a given stack (e.g., a virtual network function (VNF)), OpenStack provides “scheduler hints,” which facilitate placement of the module instances such that a single host failure, or a single rack failure, or a host aggregate failure or availability zone failure can be tolerated.

Although the scheduler hints facilitate placement of virtual machines within a given stack, the same resource pool is used to create multiple stacks and there is nothing to prevent the placement of a given type of HA virtual machine (e.g., pilots, IOs, etc.) for a subsequent stack on the same hosts that have the given type of HA virtual machine of another stack.

In at least one example embodiment, the Nova scheduler 1002 shown in FIG. 1 differs from conventional Nova schedulers in that the compute_nodes database further includes a color criterion (also referred to herein as a color value, color information, color attribute, virtual machine type indicator information), which is utilized in selecting a host on which to instantiate a virtual machine, such as a HA virtual machine.

According to at least one example embodiment, for each host (or compute node) in the pool of resources associated with the Nova scheduler 1002, the compute_nodes database stores inventory records including the following resource classes:

Colors:
compute_nodes.colors: Types of virtual machine instances currently hosted on the compute node.

vCPUs:
compute_nodes.vcpus: Count of logical CPU cores on the compute node (e.g., a 2-CPU, hex core host with hyperthreading will show up as 2×6×2=24 logical CPUs, or vCPUs).
compute_nodes.vcpus_used: Number of vCPUs already allocated to virtual machines running on the compute node.
compute_nodes.cpu_allocation_ratio: Overcommit ratio for vCPU on the compute node; this allows an operator to overcommit the resources by the given ratio (e.g., a 4:1 allocation ration would show the 24 vCPUs as 96 vCPUs).

RAM:
compute_nodes.memory_mb: Amount of physical memory in MB on the compute resource.
compute_nodes.memory_mb_used: Amount of memory allocated to virtual machines running on the compute node.
compute_nodes.ram_allocation_ratio: Overcommit ratio for memory on the compute node; similar to CPU allocation factor. This allows an operator to overcommit the memory by the specified ration, e.g., a 16:1 ratio would advertise a host with 16 GB RAM as having 256 GB RAM.
compute_nodes.free_ram_mb: Amount of free physical memory at the compute node (e.g., memory_mb−memory_mb_used).

Disk:
compute_nodes.local_gb: Amount of disk storage for virtual machine ephemeral disks.
compute_nodes.local_gb_used: Amount of disk storage allocated for ephemeral disks of virtual machines on the compute node.
compute_nodes.free_disk_gb: Similar to RAM, this is a computed value.
disk_available_least: A sum of actual used disk amounts on the compute node.

PCI Devices:
pci_stats: Stores summary information about device “pools” (per product_id and vendor_id combination).

Non-Uniform Memory Access (NUMA) Topologies:
compute_nodes.numa_topology: This represents both the compute node's NUMA topology as well as that of virtual machine instances assigned to this compute node.

An example compute_nodes database entry for a host is shown below in Table 1:

TABLE 1

| | Value |
|---|---|
| Color: | 0xfh |
| vCPUs: | |
| compute_nodes.vcpus: | 24 |
| compute_nodes.vcpus_used: | 0 |
| compute_nodes.cpu_allocation_ratio: | 4:1 |
| RAM: | |
| compute_nodes.memory_mb: | 64000 |
| compute_nodes.memory_mb_used: | 0 |
| compute_nodes.ram_allocation_ratio: | 1.5:1 |
| compute_nodes.free_ram_mb | 64000 |
| Disk: | |
| compute_nodes.local_gb: | 500 |
| compute_nodes.local_gb_used: | 0 |
| compute_nodes.free_disk_gb: | 500 |
| disk_available_least: | 500 |
| PCI Devices: | |
| Pci_stats: | . . . |
| NUMA topologies: | |
| Compute_nodes.numa_topology | . . . |

Each of the inventory records vCPUs, RAM, Disk, PCI devices and NUMA topologies are generally well-known, and thus, will not be described in detail here.

The “Color” inventory record compute_nodes.colors (also referred to as the compute_nodes.colors record) stores the above-mentioned color criterion. The color criterion may be binary data, but may also be stored in hexadecimal format as shown in Table 1. The number of bits of binary data may be determined according to the number of like HA virtual machines (or components) in the stack (e.g., VNF instance) that occur in an active/standby configuration and should be placed on different hosts. In one example, the initial value of the entry for the Color inventory record compute_nodes.colors in the database for a given host is set to all 1's to enable the host to be available to host any type of HA virtual machine.

Although discussed with regard to binary values, color criterion may be represented as characters, strings, numeric values, etc.

As will be discuss in more detail later, the Nova scheduler 1002 utilizes the color information to filter out hosts on which a HA virtual machine (e.g., from a prior stack) having the same color is already scheduled to run. As a result, scheduling of two instances of the same type of HA virtual machine across different stacks may be prevented.

According to at least some example embodiments, once a HA virtual machine is scheduled to run on a given host, the Nova scheduler 1002 flips the bit of the color value at a position associated with the type of HA virtual machine in the compute_nodes.colors record for the given host in the compute_nodes database. By changing the bit associated with a given type of HA virtual machine, this host is then filtered out for scheduling a HA virtual machine in a subsequent stack with a color (or colors) that are the same as the previously scheduled HA virtual machine. When a scheduled HA virtual machine has finished its job, is deactivated, or otherwise killed, the Nova scheduler 1002 may reclaim the resources used by the HA virtual machine. In doing so, the Nova scheduler 1002 flips back the bit associated with the type of HA virtual machine in the compute_nodes.colors record in the compute_nodes database.

In one example, a resource request may be in the form of a virtual hardware template, such as is a Heat Orchestration Template (HOT) file, which is driven by the characteristics of a host defined in an environment (ENV) file. As discussed herein, the term virtual hardware template file may be used to refer to the HOT and ENV files. However, example embodiments should not be limited to this example.

An example of a portion of the resources section of a virtual hardware template file for a virtualized Instant Enhanced Charging Collection Function (IECCF) is shown below in [Example 1]. The IECCF is an offline charging element used in IP Multimedia System (IMS) and 3^{rd} Generation Partnership Project Long Term Evolution (3GPP LTE) networks, among others. In at least some instances, example embodiments will be described with regard to the IECCF. However, it should be understood that example embodiments should not be limited to these example descriptions.

### Example 1

Node-x_flavor: 4×8×50

Node-x_image: alu-ieccf-pilot

Node-x_avail_zone: zone1

Node-x_addl_volume_avail_zone: zone1

Node-x_addl_volume_size: 50

Node-x_security_group: ieccf

Node-x_color: 0x8

In this example, the “flavor” of 4×8×50 indicates that a 4 vCPU host, with 8 GB memory and 50 GB secondary memory is being requested for instantiating “Node-x.” The virtual hardware template file in this example also specifies a number of other parameters useful in determining the resource allocation including, for example: Nova availability zone for the host (Node-x_avail_zone: zone1), Cinder availability zone for its storage requirements (Node-x_addl_volume_avail_zone:zone1), Cinder storage size requirements (Node-x_addl_volume_size: 50), and communication protocols and ports (via its security group definition, Node-x_security_group: ieccf).

Additionally, as compared to conventional HOT or ENV files, the resource section of virtual hardware template files according to one or more example embodiments are enhanced to carry color information for each HA virtual machine type relevant to the current context.

In the virtualized IECCF example, since the number of like HA virtual machines or components in the VNF instance that occur in the active/standby configuration and should be placed on different hosts is 4, the color value may have a length of 4 bits. In this example, the pilots may be assigned a color value 0x8h (1000), IOs may be assigned a color value 0x4h (0100), DB proxies may be assigned the value 0x2h (0010) and the DB OAM endpoints may be assigned the value 0x1h (0001). As can be appreciated, each sequence of bits in a color value has a single bit having a value of ‘1’, which is different from the values of the other bits. A more detailed example of a virtual hardware template file for an instance of virtualized IECCF is shown below in [Example 2].

### Example 2

### First Pilot Definition

Node-a_flavor: 4x8x50
Node-a_image: alu-ieccf-pilot
Node-a_avail_zone: zone1
Node-a_addl_volume_avail_zone: zone
Node-a_addl_volume_size: 50
Node-a_security_group: ieccf
Node-a_color: 0x8

(Paired Pilot Definition)
Node-a′_flavor: 4x8x50
Node-a′_image: alu-ieccf-pilot
Node-a′_avail_zone: zone2
Node-a′_addl_volume_avail_zone: zone
Node-a′_addl_volume_size: 50
Node-a′_security_group: ieccf
Node-a′_color: 0x8

(First IO Definition)

Node-b_flavor: 8x4x50
Node-b_image: alu-ieccf-io
Node-b_avail_zone: zone1
Node-b_security_group: ieccf
Node-b_color: 0x4

(Paired IO Definition)

Node-b′_flavor: 8x4x50
Node-b′_image: alu-ieccf-io
Node-b′_avail_zone: zone2
Node-b′_security_group: ieccf
Node-b′_color: Oz4

(First DB Proxy Definition)

Node-c_flavor: 16x4x50
Node-c_image: alu-ieccf-dbpx
Node-c_avail_zone: zone1
Node-c_security_group: ieccf
Node-c_color: 0x2

(Paired DB Proxy Definition)

Node-c′_flavor: 16x4x50
Node-c′_image: alu-ieccf-dbpx
Node-c′_avail_zone: zone2
Node-c′_security_group: ieccf
Node-c′_color: 0x2

(First OAME Definition)

Node-d_flavor: 2x4x50
Node-d_image: alu-ieccf-oame
Node-d_avail_zone: zone1
Node-d_security_group: ieccf
Node-d_color: 0x1

(Paired OAME Definition)

Node-d′_flavor: 2x4x50
Node-d′_image: alu-ieccf-oame
Node-d′_avail_zone: zone2
Node-d′_security_group: ieccf
Node-d′_color: 0x1

In the example shown above, the pilots are HA virtual machine instances of the same type; the IOs are HA virtual machine instances of the same type, but of a different type relative to the pilots; the DB Proxies are HA virtual machine instances of the same type, but of a different type relative to the pilots and the IOs; the OAMEs are HA virtual machine instances of the same type, but of a different type relative to the pilots, the IOs, and the DB Proxies.

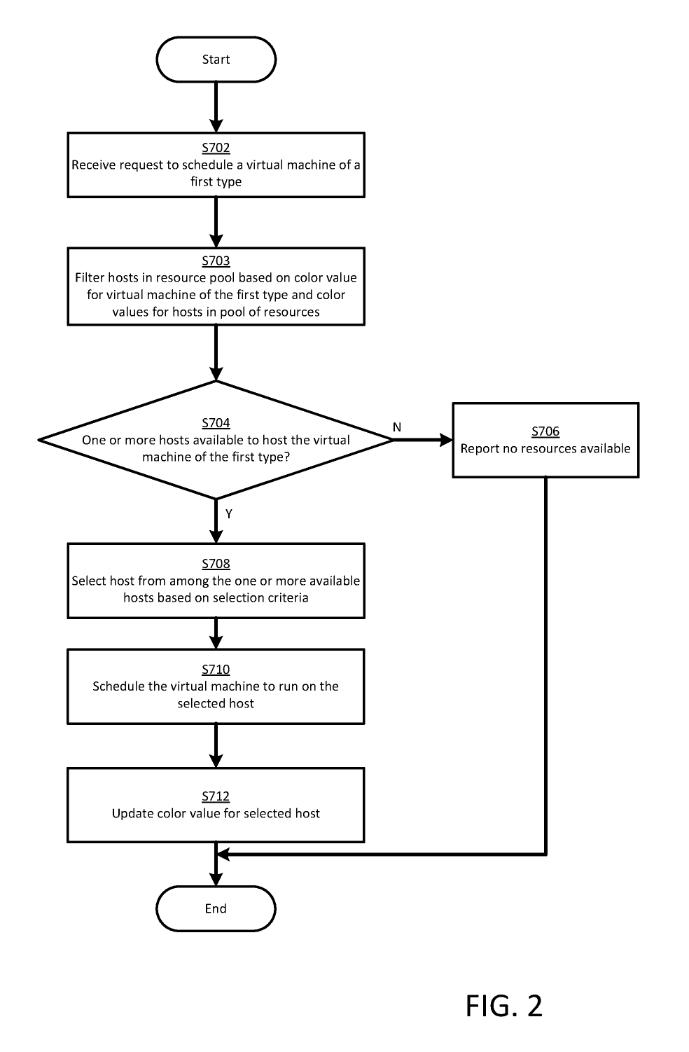

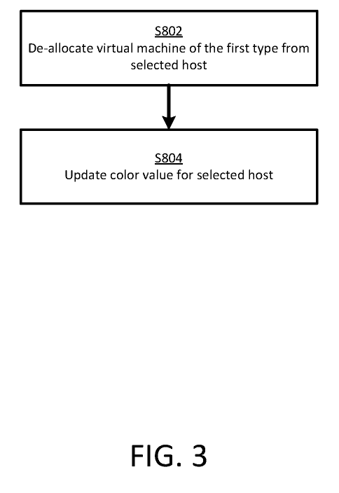

Example operation of the Nova scheduler 1002 shown in FIG. 1 will now be described in more detail with regard to FIGS. 2 and 3.

FIG. 2 is a flow chart illustrating an example embodiment of a method for network resource scheduling in a cloud deployment architecture. The method shown in FIG. 2 will be described with regard to the Nova system architecture shown in FIG. 1 for example purposes. However, example embodiments should not be limited to only this example. In this example, the hosts 102a, 102b and 102n will be considered the pool of resources associated with the Nova scheduler 1002. Although example embodiments may be described herein with regard to three hosts, example embodiments should not be limited to this example. Rather, the pool of resources may include any number of hosts, in addition to networks, storage, etc.

Referring to FIG. 2, at step S702, the Nova scheduler 1002 receives a request to schedule resources, such as instantiating a HA virtual machine of a first type. In one example, a resource demand may be received via a command line interface through the API portion of the Nova scheduler 1002. The resource demand may be in the form of a virtual hardware template file as discussed above.

In response to receiving the resource scheduling request, at step S703 the Nova scheduler 1002 filters hosts 102a, 102b and 102n in the resource pool based on the color value for the requested HA virtual machine and color values stored in the compute_nodes records for each of the hosts 102a, 102b and 102n in the compute_nodes database.

In one example, for each of the hosts 102a, 102b and 102n, the Nova scheduler 1002 examines the bit value at a position in the compute_nodes record corresponding to the position of the logic ‘1’ in the color value for the requested HA virtual machine.

For example, if the compute_nodes record comprises bit sequence b₃b₂b₁b₀, where b₃ is the most significant (MSB) and b₀ is the least significant bit (LSB), and the color value for the requested virtual machine is binary 1000, then the Nova scheduler 1002 examines the value of bit b₃ at the 4^{th} position in the compute_nodes record for each of the hosts 102a, 102b and 102n.

In another example, if the color value for the requested virtual machine is binary 0100, then the Nova scheduler 1002 examines the value of bit b₂ at the 3^{rd} position in the compute_nodes record for each of the hosts 102a, 102b and 102n.

In still another example, if the color value for the requested virtual machine is binary 0010, then the Nova scheduler 1002 examines the value of bit b₁ at the 2^{nd} position in the compute_nodes record for each of the hosts 102a, 102b and 102n.

In yet another example, if the color value for the requested virtual machine is binary 0001, then the Nova scheduler 1002 examines the value of bit b₀ at the 1^{st} position in the compute_nodes record for each of the hosts 102a, 102b and 102n.

For each of the hosts 102a, 102b and 102n, if the value of the examined bit position in the compute_nodes record is 0, then the Nova scheduler 1002 filters out that particular host as unavailable to host the requested HA virtual machine. If, however, the value of the examined bit position in the compute_nodes record is 1, then the Nova scheduler 1002 identifies the host as available to host the requested HA virtual machine. Although discussed with regard to particular bit values 0 and 1, example embodiments should not be limited to this example.

In a more specific example, if the color value for the requested HA virtual machine is binary 1000 (0x8h), the color value stored in the compute_nodes record for host 102a is binary 1111 (0xfh), the color value stored in the compute_nodes record for host 102b is binary 1111 (0xfh), and the color value stored in the compute_nodes record for host 102n is binary 0111 (0x7h), then the Nova scheduler 1002 determines that hosts 102a and 102b are available to host the requested HA virtual machine, whereas host 102n is not available. In this instance, host 102n is filtered out to identify the subset of hosts including hosts 102a and 102b on which the requested HA virtual machine may be scheduled to run.

In another example, if the color value for the requested virtual machine is binary 0100 (0x4h), the color value stored in the compute_nodes record for host 102a is binary 1111 (0xfh), the color value stored in the compute_nodes record for host 102b is binary 0111 (0x7h), and the color value stored in the compute_nodes record for host 102n is binary 0010 (0x2h), then the Nova scheduler 1002 determines that hosts 102a and 102b are available to host the requested virtual machine, whereas host 102n is not available. In this instance, host 102n is again filtered out to identify the subset of hosts including hosts 102a and 102b on which the requested HA virtual machine may be scheduled to run.

Returning to FIG. 2, at step S704 the Nova scheduler 1002 determines whether one or more of the hosts 102a, 102b and 102n in the resource pool are available to host the requested HA virtual machine based on the filtering performed at step S703. In this example, the Nova scheduler 1002 determines that one or more of the hosts 102a, 102b and 102n are available to host the requested virtual machine if one or more of the hosts 102a, 102b and 102n remain after (are not filtered out by) the filtering step S703. If the Nova scheduler 1002 determines that one or more of the hosts 102a, 102b and 102n are available to host the requested HA virtual machine, then the process continues to step S708.

In the example mentioned above in which the color value for the requested HA virtual machine is binary 1000 (0x8h) and the color values stored in the compute_nodes records for hosts 102a, 102b and 102n are binary 1111 (0xfh), binary 1111 (0xfh), and binary 0111 (0x7h), respectively, then hosts 102a and 102b are determined to be available to host the requested HA virtual machine.

In another example, if the color value for the requested virtual machine is binary 1000 (0x8h) and the color values stored in the compute_nodes records for hosts 102a, 102b and 102n are binary 1110 (0xeh), binary 1111 (0xfh), and binary 0111 (0x7h), respectively, then hosts 102a and 102b are determined to be available to host the requested HA virtual machine.

Returning to FIG. 2, at step S708, the Nova scheduler 1002 selects a host from among the subset of available hosts based on additional selection criteria associated with the requested HA virtual machine. The additional selection criteria may include characteristics set forth in the virtual hardware template file (e.g., as shown above in [Example 1] or [Example 2]), such as Nova availability zone, Cinder availability zone, Cinder storage size requirements, communication protocols and ports, etc. Because these criteria, and the manner in which they are utilized is generally well-known, a detailed discussion is omitted.

Also at step S708, if the Nova scheduler 1002 determines that there are two or more hosts available to host a given HA virtual machine instance, then the Nova scheduler 1002 chooses the host that is currently hosting the least number of HA virtual machines. If, however, each of the available hosts is currently hosting the same number of HA virtual machine instances, then the Nova scheduler 1002 may select from among the available hosts randomly.

For example, in the scenario discussed above in which the color value for the requested virtual machine is binary 1000 (0x8h), the compute_nodes record for host 102a is binary 1111 (0xfh) and the color value stored in the compute_nodes record for host 102b is binary 1111 (0xfh), a host among these two hosts may be selected randomly since neither host 102a nor 102b currently hosts a HA virtual machine.

In the scenario discussed above in which the color value for the requested virtual machine is binary 1000 (0x8h), the color value stored in the compute_nodes record for host 102a is binary 1110 (0xeh), and the color value stored in the compute_nodes record for host 102b is binary 1111 (0xfh), the Nova scheduler 1002 selects the host 102b since this host is not currently hosting any HA virtual machines (e.g., from other stacks), whereas host 102a is currently hosting one HA virtual machine (indicated by the bit ‘0’ at the 1^{st} position in the color value stored in the compute_nodes record for the host 102a).

Returning to FIG. 2, after selecting a host from among the available hosts 102a and 102b, at step S710 the Nova scheduler 1002 schedules the requested HA virtual machine to run on the selected host. Because methods for scheduling a requested HA virtual machine to run on a host are generally well-known, a detailed discussion is omitted.

At step S712, after scheduling the requested HA virtual machine to run on the selected host, the Nova scheduler 1002 updates the color value stored in the compute_nodes record for the selected host to indicate that the requested HA virtual machine is running (or scheduled to run) on the selected host.

Referring back to the example in which the host 102a has an initial color value 1111, if the Nova scheduler 1002 ultimately schedules the requested HA virtual machine to run on the host 102a, then the Nova scheduler 1002 may update the color value stored in the compute_nodes record for the host 102a with a new value, which is different from the initial color value.

For example, if the color value for the requested HA virtual machine is binary 1000, then the updated color value to be stored in the compute_nodes record for the host 102a may be obtained by performing an XOR operation between the initial (or current) color value for the host 102a (binary 1111) and the color value for the requested HA virtual machine (binary 1000) to obtain the updated color value of binary 0111 (0x7h) to be stored in the compute_nodes record. By using the XOR operation, an appropriate bit in the color value stored in the compute_nodes record for the host 102a is essentially flipped. The bit in the color value stored in the compute_nodes record may be at a position corresponding to the position of the ‘1’ in the color value for the requested HA virtual machine.

By flipping the bit of the color value stored in the compute_nodes record for the host 102a, this host is filtered out in response to a next call to the Nova scheduler 1002 requesting instantiation of a HA virtual machine in another stack with a color value of binary 1000.

In the example in which the color value for the requested virtual machine is binary 0100, and the initial (or current) color value stored in the compute_nodes record for the host 102a is binary 1111, the updated color value for the host 102a may be obtained by performing an XOR operation between the initial (or current) color value stored in the compute_nodes record for the host 102a (binary 1111) and the color value for the requested HA virtual machine (binary 0100) to obtain the updated color value of binary 1011 (0xbh) to be stored in the compute_nodes record. By using the XOR operation, the 3^{rd} bit position of the color value stored in the compute_nodes record for the host 102a is essentially flipped.

By flipping the value of the bit at the 3rd position of the color value stored in the compute_nodes record for the host 102a, this host is filtered out in response to a next call to the Nova scheduler 1002 requesting instantiation of a HA virtual machine in another stack with a color value 0100.

An example pre- and post-allocation entry for a compute_nodes record for a host after having assigned a virtualized IECCF virtual machine instance having a color value 0x8h (1000) to a host having the initial compute_nodes record entry values shown above in Table 1 is shown below in Table 2.

TABLE 2

| | Initial | After |
|---|---|---|
| | Value | Allocation |
| Color: | 0xfh | 0x7h |
| vCPUs: | | |
| compute_nodes.vcpus: | 24 | 24 |
| compute_nodes.vcpus_used: | 0 | 4 |
| compute_nodes.cpu_allocation_ratio: | 4:1 | 4:1 |
| RAM: | | |
| compute_nodes.memory_mb: | 64000 | 64000 |
| compute_nodes.memory_mb_used: | 0 | 8000 |
| compute_nodes.ram_allocation_ratio: | 1.5:1 | 1.5:1 |
| compute_nodes.free_ram_mb | 64000 | 56000 |
| Disk: | | |
| compute_nodes.local_gb: | 500 | 500 |
| compute_nodes.local_gb_used: | 0 | 50 |
| compute_nodes.free_disk_gb: | 500 | 450 |
| disk_available_least: | 500 | 500 |
| PCI Devices: | | |
| Pci_stats: | . . . | . . . |
| NUMA topologies: | | |
| Compute_nodes.numa_topology | . . . | . . . |

Returning to step S704 in FIG. 2, if the Nova scheduler 1002 determines that none of the hosts 102a, 102b and 102n are available to host the requested HA virtual machine based on the filtering performed at step S703 (e.g., all of hosts 102a, 102b and 102n have been filtered out, and there are no resources available to host the requested HA virtual machine), then the Nova scheduler 1002 reports no resources available by sending a call back to the API. The call back to the API indicates that no resources are available to host the requested HA virtual machine (e.g., failure to allocate a resource). The Nova scheduler 1002 may indicate that no resources are available when the resource pool is exhausted (e.g., out of resources altogether, or out of resources that match the desired characteristics). In this instance, the attempt to create the requested HA virtual machine may fail. As a result, the stack creation may fail and may not be realized.

In certain edge scenarios, resource demands may not be met as the filtering criterion fails. In these cases, the Nova scheduler 1002 may provide a warning to a network operator that the resource demands cannot be met because of the filtering criteria. In this case, the operator may override the filtering criteria by, for example: (a) reducing the filtering requirements, such that HA constraints are not advertised for the HA virtual machine being allocated; (b) altering the representation of the color characteristics of a HA virtual machine from being a binary data type to a counting integer, incrementing and decrementing its value upon allocation and de-allocation respectively, such that HA virtual machines or components of the same type may be allocated on the same host, but such allocations and de-allocations are still accounted for to aid the Nova scheduler 1002 to handle such placements; or (c) a combination of these and other possible methods.

As mentioned above, when a HA virtual machine has finished its job, or is deactivated, or otherwise killed, the Nova scheduler 1002 may reclaim the resources used by the de-scheduled HA virtual machine. In doing so, the Nova scheduler 1002 may again perform an XOR operation between the color value for the de-scheduled HA virtual machine and the color value stored in the compute_nodes record for the host. By performing the XOR operation, the appropriate bit value is flipped back to the previous value such that a same type of HA virtual machine in a subsequent stack may be allocated to the host. An example embodiment of a method for network de-scheduling will be described in more detail below with regard to FIG. 3.

FIG. 3 is a flow chart illustrating an example embodiment of a method for network resource de-scheduling for cloud deployment. As with FIG. 2, the method shown in FIG. 3 will be described with regard to the Nova system architecture shown in FIG. 1 for the example purposes. However, example embodiments should not be limited to only this example. In this example, the host 102a is assumed to have been chosen by the Nova scheduler 1002 to run a HA virtual machine of a pilot, which has a color value of binary 1000, and the current color value entry for the host 102a is 0111.

At step S802, the Nova scheduler 1002 de-allocates or de-schedules the scheduled HA virtual machine from the host 102a. Because methods for deallocation and de-scheduling virtual machines are generally well-known, a detailed discussion is omitted.

After deallocating or de-scheduling the virtual machine from the host 102a, at step S804 the Nova scheduler 1002 updates the database entry for the host 102a to reflect the resources released as a result of the deallocation/descheduling of the HA virtual machine. Additionally, the Nova scheduler 1002 updates the color value stored in the compute_nodes record for the host 102a such that, in this example, the bit value at the fourth position of the color value stored in the compute_nodes record is returned to a value of 1 while the remaining bit values are unchanged.

For example, when a HA virtual machine is de-allocated/de-scheduled from a host, the Nova scheduler 1002 may update the color value stored in the compute_nodes record by storing the result of an XOR operation between the current color value stored in the compute_nodes record and the color value for the de-allocated/descheduled HA virtual machine. The XOR operation may be performed in essentially the same manner as discussed above with regard to when the HA virtual machine is scheduled, and thus, further discussion is omitted.

According to one or more example embodiments, not all requested virtual machine instances are expected to be HA type (HA virtual machines). For virtual machines that are not HA virtual machines, the color value for the requested virtual machine instance may be NULL (no explicit color demand). In this case, neither scheduling nor de-scheduling the non-HA virtual machine on/from a host alters a host's color value.

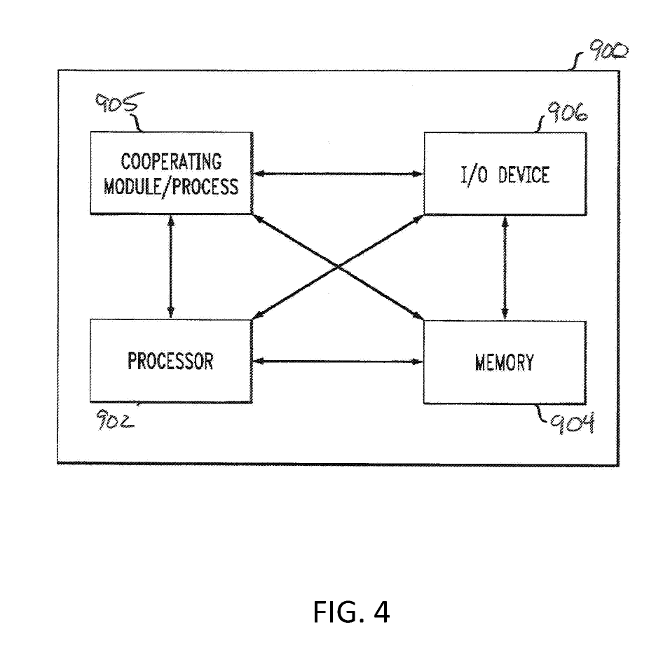

FIG. 4 depicts a high-level block diagram of a computer or computing device suitable for use in performing the operations and methodology described herein. The computer 900 includes one or more processors 902 (e.g., a central processing unit (CPU) or other suitable processor(s)) and a memory 904 (e.g., random access memory (RAM), read only memory (ROM), and the like).

The computer 900 also may include a cooperating module/process 905. The cooperating process 905 may be loaded into memory 904 and executed by the processor 902 to implement functions as discussed herein and, thus, cooperating process 905 (including associated data structures) may be stored on a computer readable storage medium (e.g., RAM memory, magnetic or optical drive or diskette, or the like).

The computer 900 also may include one or more input/output devices 906 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 900 depicted in FIG. 4 provides a general architecture and functionality suitable for implementing functional elements described herein or portions of functional elements described herein. For example, the computer 900 provides a general architecture and functionality suitable for implementing one or more of a host, scheduler, server, or other network entity, which hosts the methodology for described herein according to the principles of the invention. For example, a processor of a server or other computer device may be configured to provide functional elements that implement in the functionality discussed herein.

One or more example embodiments may be applicable to OpenStack Heat. According to at least one example embodiment, when OpenStack Heat is in the process of orchestration, a host that is compatible with the resource needs of a requested virtual machine being launched and also available to host the type of virtual machine being requested (sometimes referred to as showing “color compatibility”) is selected. Once selected, the virtual machine is instantiated on the selected host, and the host updates its virtual machine type indicator information to reflect that the particular type of virtual machine is being hosted at the selected host (sometimes referred to as assuming the color property of the hosted virtual machine). When a subsequent virtual machine of the same type is to be instantiated, the color compatibility is evaluated such that the virtual machine of the same type is not instantiated on the host if the prior instantiated virtual machine is still running on the host.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

Reference is made in detail to embodiments, examples of which are illustrated in the accompanying drawings, wherein like reference numerals refer to the like elements throughout. In this regard, the example embodiments may have different forms and should not be construed as being limited to the descriptions set forth herein. Accordingly, the example embodiments are merely described below, by referring to the figures, to explain example embodiments of the present description. Aspects of various embodiments are specified in the claims.

What is claimed s:

1. A method for network resource scheduling in a cloud network environment including a plurality of hosts, the method comprising:
determining whether one or more hosts from among the plurality of hosts are available to host a first virtual machine by filtering the plurality of hosts based on (i) first virtual machine type indicator information associated with a request to schedule the first virtual machine and (ii) second virtual machine type indicator information associated with the plurality of hosts;
selecting a host from among the one or more hosts based on selection criteria associated with the filtered plurality of hosts, if the determining determines that one or more hosts are available to host the first virtual machine;
scheduling the first virtual machine to run on the selected host; and
updating the second virtual machine type indicator information for the selected host to indicate that the first virtual machine is scheduled to run on the selected host.

2. The method of claim 1, wherein
the first virtual machine type indicator information includes at least one first bit;
the second virtual machine type indicator information includes a plurality of second bits; and
the updating includes changing a value of at least one second bit among the plurality of second bits, based on the first virtual machine type indicator information.

3. The method of claim 2, wherein
the plurality of second bits is a sequence of bits in the form of a binary value; and
the at least one second bit among the plurality of second bits is a second bit at a position in the sequence of bits corresponding to the type of virtual machine indicated by the first virtual machine type indicator information.

4. The method of claim 1, wherein the filtering comprises:
filtering out hosts currently hosting a same type of virtual machine as the first virtual machine, from among the plurality of hosts, to identify a subset of the plurality of hosts; and wherein
the selecting step selects the host from among the subset of the plurality of hosts.

5. The method of claim 1, wherein the selection criteria for a host among the filtered plurality of hosts includes at least one of:
available CPU resources at the host;
available random access memory resources at the host;
available memory storage at the host;
information associated with device pools at the host;
topology information associated with the host; or
hosted virtual machine indicator information regarding virtual machine instances hosted by the host.

6. The method of claim 1, further comprising:
de-scheduling the first virtual machine from the selected host; and
updating the second virtual machine type indicator information for the selected host to indicate that the first type of virtual machine has been de-scheduled from the selected host.

7. The method of claim 1, wherein
the first virtual machine is a high availability virtual machine;
the determining determines that two or more hosts are available to host the first virtual machine; and
the selecting selects a host from among the two or more hosts based on a number of high availability virtual machines currently hosted on each of the two or more hosts.

8. The method of claim 7, wherein the selecting selects the host, from among the two or more hosts, currently hosting a least number of high availability virtual machines.

9. The method of claim 1, wherein the first virtual machine is a virtual network function including a plurality of virtual machine instances.

10. A server to schedule network resources in a cloud network environment including a plurality of nodes, the server comprising:
a memory storing computer readable instructions; and
one or more processors connected to the memory, the one or more processors configured to execute the computer readable instructions to
determine whether one or more hosts from among the plurality of hosts are available to host a first virtual machine by filtering the plurality of hosts based on (i) first virtual machine type indicator information associated with a request to schedule the first virtual machine and (ii) second virtual machine type indicator information associated with the plurality of hosts,
select a host from among the one or more hosts based on selection criteria associated with the filtered plurality of hosts, if one or more hosts are available to host the first virtual machine,
schedule the first virtual machine to run on the selected host, and
update the second virtual machine type indicator information for the selected host to indicate that the first virtual machine is scheduled to run on the selected host.

11. The sever of claim 10, wherein
the first virtual machine type indicator information includes at least one first bit;
the second virtual machine type indicator information includes a plurality of second bits; and
the one or more processors are further configured to execute the computer readable instructions to change a value of at least one second bit among the plurality of second bits, based on the first virtual machine type indicator information.

12. The server of claim 11, wherein
the plurality of second bits is a sequence of bits in the form of a binary value; and
the at least one second bit among the plurality of second bits is a second bit at a position in the sequence of bits corresponding to the type of virtual machine indicated by the first virtual machine type indicator information.

13. The server of claim 10, wherein the one or more processors are further configured to execute the computer readable instructions to
filter out hosts currently hosting a same type of virtual machine as the first virtual machine, from among the plurality of hosts, to identify a subset of the plurality of hosts; and
select the host from among the subset of the plurality of hosts.

14. The server of claim 10, wherein the one or more processors are further configured to execute the computer readable instructions to
de-schedule the first virtual machine from the selected host; and
update the second virtual machine type indicator information for the selected host to indicate that the first type of virtual machine has been de-scheduled from the selected host.

15. The server of claim 10, wherein
the first virtual machine is a high availability virtual machine; and
the one or more processors are further configured to execute the computer readable instructions to
determine that two or more hosts are available to host the first virtual machine, and
select a host from among the two or more hosts based on a number of high availability virtual machines currently hosted on each of the two or more hosts.

16. The server of claim 15, wherein the one or more processors are further configured to execute the computer readable instructions to select the host, from among the two or more hosts, currently hosting a least number of high availability virtual machines.

17. A non-transitory computer-readable storage medium storing computer readable instructions that, when executed by one or more processors, cause the one or more processors to perform a method for network resource scheduling in a cloud network environment including a plurality of hosts, the method comprising:
determining whether one or more hosts from among the plurality of hosts are available to host a first virtual machine by filtering the plurality of hosts based on (i) first virtual machine type indicator information associated with a request to schedule the first virtual machine and (ii) second virtual machine type indicator information associated with the plurality of hosts;
selecting a host from among the one or more hosts based on selection criteria associated with the filtered plurality of hosts, if the determining determines that one or more hosts are available to host the first virtual machine;
scheduling the first virtual machine to run on the selected host; and
updating the second virtual machine type indicator information for the selected host to indicate that the first virtual machine is scheduled to run on the selected host.

18. The non-transitory computer-readable storage medium of claim 17, wherein
the first virtual machine type indicator information includes at least one first bit;
the second virtual machine type indicator information includes a plurality of second bits; and
the updating includes changing a value of at least one second bit among the plurality of second bits, based on the first virtual machine type indicator information.

19. The non-transitory computer-readable storage medium of claim 17, wherein the filtering comprises:
filtering out hosts currently hosting a same type of virtual machine as the first virtual machine, from among the plurality of hosts, to identify a subset of the plurality of hosts; and wherein
the selecting step selects the host from among the subset of the plurality of hosts.

20. The non-transitory computer-readable storage medium of claim 17, wherein the method further comprises:
de-scheduling the first virtual machine from the selected host; and
updating the second virtual machine type indicator information for the selected host to indicate that the first type of virtual machine has been de-scheduled from the selected host.
